(19) United States
(12) Patent Application Publication
(10) Pub. No.: US 2009/0127933 A1
(43) Pub. Date: May 21, 2009

(54) Uninterruptible Power Supply With Additional Feeding

(75) Inventor: Giuseppe Simonazzi, Reggio Emilia (IT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: META SYSTEM S.P.A.

(21) Appl. No.: 11/887,376

(22) PCT Filed: Apr. 7, 2006
(86) PCT No.: PCT/IB2006/000804

§ 371 Date: Sep. 28, 2007

(30) Foreign Application Priority Data
Apr. 8, 2005 (IT) MO2005A000082

(51) Int. Cl. H02J 9/06; H02J 7/35

(52) U.S. Cl. 307/66; 320/101

(57) ABSTRACT

UPS unit comprising power step-up means connected to the power mains and conversion means able to produce an AC output voltage, battery supply means being connectable, by switching means, to said power step-up means, whose peculiar aspect is that it comprises at least one additional power supply source, connected to power step-up means, connected in turn to said conversion means, said additional power supply source being able to power the downstream loads of said UPS unit, when a first power threshold pre-set in said power step-up means of said additional power supply source is reached, said additional power supply being able to be integrated by said power mains or said battery.

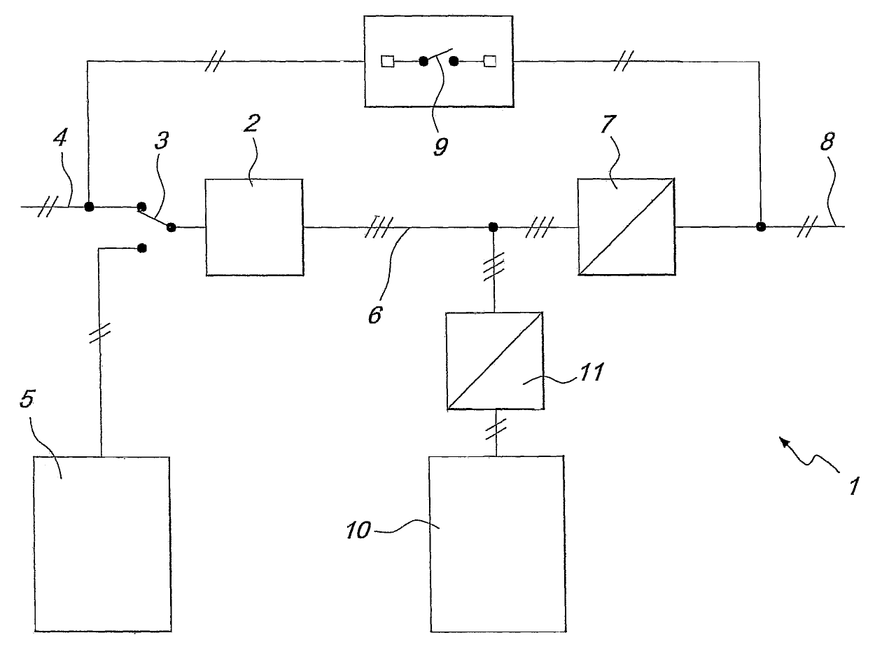

### TECHNICAL FIELD

The present invention concerns an Uninterruptible Power Supply with additional feeding; more specifically, the invention concerns a UPS unit that can be powered from the power mains, by battery or by means of an auxiliary power supply.

### BACKGROUND ART

As is known, UPS units are normally used to offset power breaks due for instance to sudden blackouts or temporary network faults.

UPS units are especially important in those situations in which the permanent power supply to appliances and devices is of vital importance such as, for instance in hospitals, banks and similar.

Currently known UPS units are connected directly to the mains supply and foresee the presence of batteries that intervene to supply downstream loads in the event of the mains supply being interrupted.

Normally, the UPS units make a double conversion from alternate current to direct current and from direct current to equivalent alternate current to supply the downstream load. These conversions produce a drop in efficiency.

### DISCLOSURE OF THE INVENTION

The primary aim of the present invention is to make a UPS unit powered from both the mains, with a back-up battery, and from an auxiliary supply source.

As part of this aim, a purpose of the present invention is to make a UPS unit in which the auxiliary supply source is able to integrate both the mains voltage, when this is present, and the battery voltage, when the battery of the UPS unit powers the load connected to the mains.

Another aim of this invention is to make a UPS unit that permits achieving energy saving during operation compared to UPS units of known type.

Not the last aim of this invention is to make a UPS unit that is both highly reliable, easy to make and with a competitive cost.

This aim, as well as these and other purposes better explained below, are achieved by a UPS unit comprising power step-up means connected to the power mains and conversion means able to produce an AC output voltage, battery supply means being connectable, by switching means, to said power step-up means, characterized in that it comprises at least one additional power supply source, connected to power step-up means, connected in turn to said conversion means, said additional power supply source being able to power the downstream loads of said UPS unit, when a first power threshold pre-set in said power step-up means of said additional power supply source is reached, said additional power supply being able to be integrated by said power mains or said battery.

### BRIEF DESCRIPTION OF THE DRAWINGS

Further characteristics and advantages of the invention will appear even more evident from the description of a preferred, but not exclusive, embodiment of the UPS unit according to the invention, illustrated by way of non limiting example in the accompanying drawing, wherein the only FIGURE shows a block diagram of the UPS unit according to the present invention.

### WAYS OF CARRYING OUT THE INVENTION

With reference to the FIGURE, the UPS unit according to the present invention, generally designated by reference numeral 1, comprises the power step-up means 2 also able to carry out a power factor correction, which are connected, by the switching means 3, to the power mains 4, or to a battery 5 which takes the place of the stage in which the mains 4 is deficient.

When the switching means 3 close the connection on the power mains 4, the power step-up means 2 operate as a power factor correction device, while when the switching means 3 close on the battery 5, the power step-up means 2 operate as power step-up and carry out a double conversion from alternate current to direct current and from direct current to direct current.

The output of the power step-up means 2 is a double bus 6 with high voltage, uninterruptible, which powers the inverter means 7 which produce a conversion from direct current to alternate current and output the alternate voltage onto line 8.

A bypass circuit is envisaged to bypass the electronics of the UPS unit, by connecting the mains directly to the output, for safety reasons, for instance in the case of an overload, so as to be able to preserve the electronics of the UPS unit, or due to bad operation of the UPS unit itself.

The bypass circuit, indicated by reference numeral 9, comprises bypass switch means, able to allow direct connection between the power mains 4 and the output 8, or, in the case of the means 9 being open, to allow normal connection between the mains and the output by means of the electronics of the UPS unit.

The peculiar features of the invention lie in the fact that at least one solar panel 10 is envisaged, able to release energy for powering a load directly or for assisting the power voltage produced either by the power mains 4, or the battery 5 in the case of the mains supply being disconnected.

The solar panel 10 is therefore connected to the power step-up means 11 which are set with a first power threshold higher than a second power threshold set in the power step-up means 2. The output of the power step-up means 11 is also inputted to the inverter means 7.

In the event of the power from the solar panel 10 being such as to reach the first pre-set threshold, power is supplied to the loads connected to the mains by means of the UPS unit using the energy from the solar panel 10.

In the case of the solar panel no longer being able to provide a power supply equal to the first pre-set threshold, the mains integrates the missing power, if the mains is connected, or else this job is done by the battery 5.

Basically, the UPS unit according to the invention provides for the operation of the load connected to the mains, by means of the UPS unit, using not the mains power, but first of all, with priority, the power generated by the solar panel 10, and only subsequently, meaning if this power voltage is insufficient, by the mains power, if this is present, or power from the battery 5 if the UPS unit is operating with the mains disconnected.

In practice, it has been found that the UPS unit according to the present invention fully achieves the preset aim and purposes, as it permits achieving an energy saving using the UPS unit itself, by virtue of the power supply provided by at least one solar panel, so as to be able to power the downstream loads, or else the solar panel energy can be integrated by the mains power when this is present, or by the battery power.

The UPS unit thus conceived is susceptible of numerous modifications and variations, all of which falling within the scope of the inventive concept; furthermore all the details can be replaced with other elements that are technically equivalent.

1. UPS unit, comprising power step-up means connected to the power mains and conversion means able to produce an AC output voltage, battery supply means being connectable, by switching means, to said power step-up means, wherein it comprises at least one additional power supply source, connected to power step-up means, connected in turn to said conversion means, said additional power supply source being able to power the downstream loads of said UPS unit, when a first power threshold pre-set in said power step-up means of said additional power supply source is reached, said additional power supply being able to be integrated by said power mains or said battery.

2. UPS unit according to claim 1, wherein said additional power supply source comprises at least one solar panel.

3. UPS unit according to claim 1, comprising a bypass circuit able to directly connect said power mains to the output of said inverter means.

4. UPS unit according to claim 1, wherein said power step-up means connected to said power mains are able to carry out a power factor correction of said power mains when said power step-up means are connected to said power mains.

5. UPS unit according to claim 1, wherein said power step-up means connected to said power mains have a second pre-set power threshold, lower than said first pre-set power threshold in said first power step-up means of said auxiliary power source.
